(19) United States
(12) Patent Application Publication
(10) Pub. No.: US 2026/0100944 A1
(43) Pub. Date: Apr. 9, 2026

(54) SYSTEMS AND METHODS FOR AUTOMATICALLY ROTATING PASSWORDS IN A MULTI-SERVER ENVIRONMENT

(71) Applicant: BANK OF AMERICA CORPORATION, Charlotte, NC (US)

(72) Inventors: Daniel Christopher Dunn, Charlotte, NC (US); Leonard William Burt, Essex (GB); Smitha Gudur, Jersey City, NJ (US); Laxminarayana Koutarapu, Hyderabad (IN)

(73) Assignee: BANK OF AMERICA CORPORATION, Charlotte, NC (US)

(21) Appl. No.: 18/905,913

(22) Filed: Oct. 3, 2024

(51) Int. Cl. H04L 9/40

(52) U.S. Cl. CPC H04L 63/083

(57) ABSTRACT

Systems, computer program products, and methods are described herein for systems and methods for automatically rotating passwords in a multi-server environment. The present disclosure is configured to identify, from at least one of an external source or an internal source, at least one authentication credential comprising a password rotation requirement associated with at least one server, to transmit, using a temporary credential, a request to an application programming interface (API) to rotate passwords associated with the at least one authentication credential, to receive, from the API, the rotated password associated with the at least one authentication credential, and to update the at least one authentication credential with the rotated password.

### TECHNOLOGICAL FIELD

Example embodiments of the present disclosure relates to cyber security in rotating passwords in a multi-server environment.

### BACKGROUND

In the fields of data security and network security, the rotation of passwords is a critical measure to prevent unauthorized access to sensitive database and confidential data. Typically, data security protocols require that password policies mandate the regular changing or resetting of passwords and other privileged credentials at specified intervals. Additionally, as computing power continues to advance and with the introduction of new technologies, such as quantum computing, there is an increasing demand for longer and more complex passwords. To comply with these stringent password change policies, software interfaces have been developed that allow users to manage their authentication credentials. However, these software interfaces may encounter operational limitations and constraints when deployed on certain network servers, rendering them ineffective in such environments. Thus, a system for automatically, dynamically, and securely rotating passwords in a multi-server environment would resolve the technical problems identified herein.

Applicants have identified a number of deficiencies and problems associated with automatically rotating passwords in a multi-server environment. Through applied effort, ingenuity, and innovation, many of these identified problems have been solved by developing solutions that are included in embodiments of the present disclosure, many examples of which are described in detail herein.

### BRIEF SUMMARY

Systems and methods, and computer program products are provided for automatically rotating passwords in a multi-server environment.

In one aspect, a system for automatically rotating password in multi-server environment is provided. In some embodiments, the system may comprise: a memory device with computer-readable program code stored thereon; at least one processing device operatively coupled to the at least one memory device and the at least one communication device, wherein executing the computer-readable code is configured to cause the at least one processing device to: identify, from at least one of an external source or an internal source, at least one authentication credential comprising a password rotation requirement associated with at least one server; transmit, using a temporary credential, a request to an application programming interface (API) to rotate passwords associated with the at least one authentication credential; receive, from the API, the rotated password associated with the at least one authentication credential; and update the at least one authentication credential with the rotated password.

In some embodiments, executing the computer-readable code is configured to cause the at least one processing device to: store the at least one authentication credential comprising the password rotation requirement in at least one data storage.

In some embodiments, the external source is a data storage component or an API metadata from the API, or the internal source comprises a server metadata associated with the at least one server.

In some embodiments, the temporary credential is a token, and wherein the token comprises an automatic expiration at a pre-defined threshold time.

In some embodiments, the at least one authentication credential is associated with at least one of: a standalone server authentication credential, a Virtual Network Name (VNN) authentication credential that has access to an Always-On-Always-Available Group (AOAG), a report authentication credential in a Structured Query Language (SQL) Server Reporting Services (SSRS) server, a package authentication credential in a SQL Server Integration Services (SSIS) server, a package configuration authentication credential in SSIS server, a multi-dimensional cube authentication credential in a SQL Server Analysis Services (SSAS) server, or a tabular cube authentication credential in the SSAS server.

In some embodiments, executing the computer-readable code is further configured to cause the at least one processing device to: connect at least one node associated with the AOAG to the VNN authentication credential, wherein the authentication credential is the VNN authentication credential; and update the at least one node with the rotated password associated with the VNN authentication credential. In some embodiments, executing the computer-readable code is further configured to cause the at least one processing device to: parse SSRS server to identify the at least one of report authentication credential, wherein the authentication credential is the report authentication credential; update the report authentication credential with the rotated password associated with the report authentication credential. In some embodiments, executing the computer-readable code is further configured to cause the at least one processing device to: parse at least one file system, at least one database, and at least one SSIS database (SSISDB) to identify the package authentication credential, the package configuration authentication credential, or a value type of the package, wherein the authentication credential is the package authentication credential or the package configuration authentication credential; and update the package authentication credential, wherein, in an instance where the package authentication credential and the package configuration authentication credential are identified, update the package authentication credential and the package configuration authentication credential with the rotated password, or wherein, in an instance where the value type of the package is identified, update the package authentication credential with the rotated password. In some embodiments, executing the computer-readable code is further configured to cause the at least one processing device to: parse the SSAS server; identify, based on the parsing of the SSAS server, a multi-dimensional cube format of the SSAS server or a tabular cube format of the SSAS server, wherein the multi-dimensional cube format comprises the multi-dimensional cube authentication credential and wherein the tabular cube format comprises the tabular cube authentication credential; and update the multi-dimensional cube authentication credential or the tabular cube authentication credential, wherein, in an instance where the multi-dimensional cube format is identified, update the multi-dimensional cube authentication credential with the rotated password, or wherein, in an instance where the tabular cube format is identified, update the tabular cube authentication credential with the rotated password.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for automatically rotating passwords in a multi-server environment, in accordance with an embodiment of the disclosure;

FIG. 2 illustrates a process flow for automatically rotating passwords (ARP) in a multi-server environment, in accordance with an embodiment of the disclosure;

FIG. 3 illustrates a process flow for collecting metadata information of authentication credentials in a multi-server network, in accordance with an embodiment of the disclosure;

FIG. 4 illustrates a process flow for the password rotating process of a high availability cluster by the ARP system, in accordance with an embodiment of the disclosure;

FIG. 5 illustrates a process flow for the password rotating process of the SQL Server Reporting Services (SSRS) server by the ARP system, in accordance with an embodiment of the disclosure;

FIG. 6A-6B illustrates a process flow for the password rotating process of the SQL Server Integration Services (SSIS) server by the ARP system, in accordance with an embodiment of the disclosure;

FIG. 7 illustrates a process flow for the password rotating process of the SQL Server Analysis Services (SSAS) server by the ARP system, in accordance with an embodiment of the disclosure;

FIG. 8 illustrates a process flow for collecting metadata information of authentication credentials in multi-server network, in accordance with an embodiment of the disclosure;

FIG. 9 illustrates a metadata collecting process, in accordance with an embodiment of the disclosure;

FIG. 10 illustrates a process flow for the password rotating process of the servers in multi-server network by the ARP system, in accordance with an embodiment of the disclosure; and

FIG. 11 overall components associated with ARP system in multi-server environment, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository—a storage location where one or more resources are organized, stored and retrieved electronically using a computing device.

As previously discussed, data security protocols generally require that password policies enforce the regular alteration or resetting of passwords and other privileged credentials at specified intervals. With the continuous advancement of computing power, the need for longer and more complex passwords has become increasingly significant. In response to these rigorous password change requirements, software interfaces have been developed to enable user(s) to manage their authentication credentials within a centralized storage system that provides stringent passwords and password rotation.

However, these software interfaces may encounter operational limitations and constraints when deployed on certain network servers, resulting in ineffectiveness within a multi-server network environment. Password rotation may be executed by initially rotating the password within the password storage, followed by subsequently updating the rotated password in a target object. To update the target object with the rotated password, the software interfaces must locate the target object and the location of the password within the server. Certain servers may perform specific roles within multi-server networks and possess specialized configurations to fulfill those roles. Consequently, due to these specialized configuration settings, the software interfaces may be unable to analyze these servers.

The system described herein is configured to retrieve authentication credentials requiring password rotation from the software interface, locate the target objects associated with the authentication credential within the specialized servers, perform the password rotation using the software interfaces, and receive the rotated password from the software interfaces. The system then updates the rotated password in the target object. To expedite the process, the system may preemptively collect target objects from the specialized servers and store them in a centralized storage. This allows the system to later locate the target objects without the need to search for them each time.

Accordingly, the present disclosure receives a temporary credential from a user(s), whereby the temporary credential allows an application programming interface (API) to rotate passwords associated with an authentication credential comprising a password rotation requirement. In typical systems, the API may be unable to access the specialized server due to its lack of capabilities, which thus, inhibits the password rotation process. However, and in present disclosure, the system may obtain information on the user's authentication credentials from the API by using the temporary credential. This information is then used to locate the target objects within the specialized servers. The system subsequently rotates the passwords associated with the target objects using the API, receives the rotated passwords from the API, and updates the target objects with the rotated passwords. The system may preemptively collect information on target objects prior to a user request, using the collected information to expedite the process of identifying the target objects.

What is more, the present disclosure provides a technical solution to a technical problem. As described herein, the technical problem comprises automatically rotating passwords in a multi-server environment, identifying the target objects within specialized servers for automatic password rotation, and automatically rotating the passwords in a data secure manner. The technical solution presented herein enables the automatic rotation of passwords in the multi-server environment, the identification of target objects within specialized servers by parsing and analyzing server configurations.

In particular, identifying the location of target object (such as within the multi-server environment and/or the specialized server environment) and managing the location information of target object is an improvement over existing solutions to the manually managing the password rotation process, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

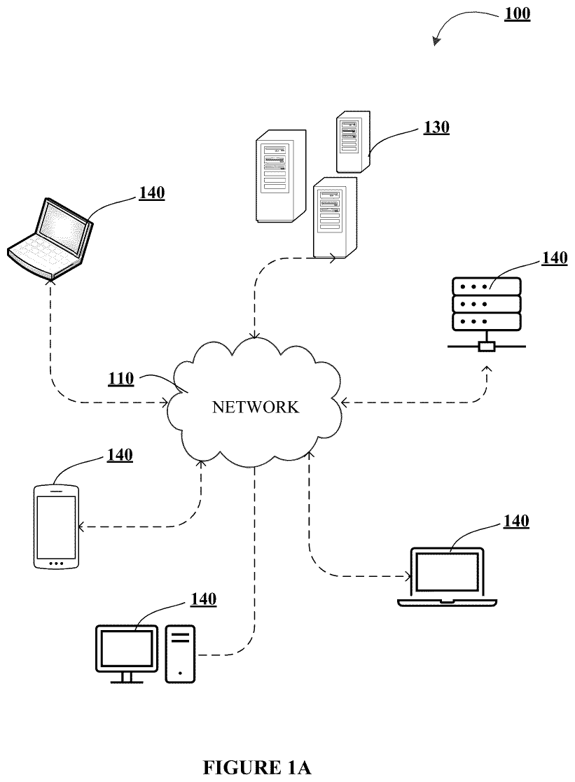

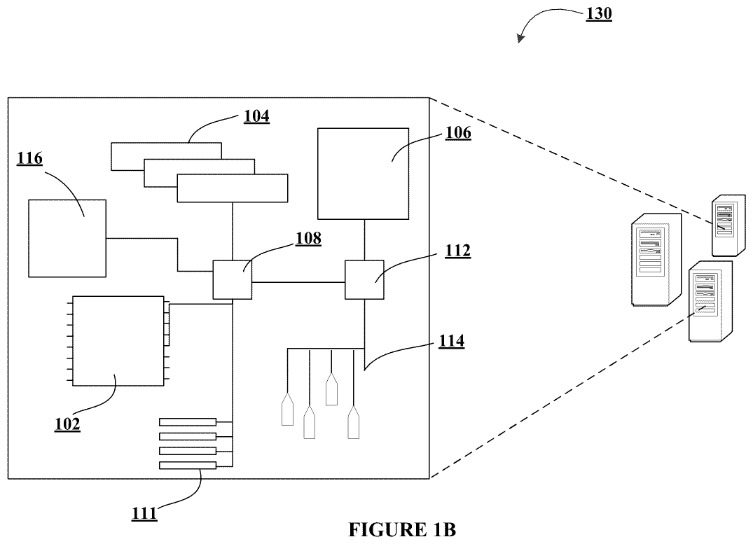

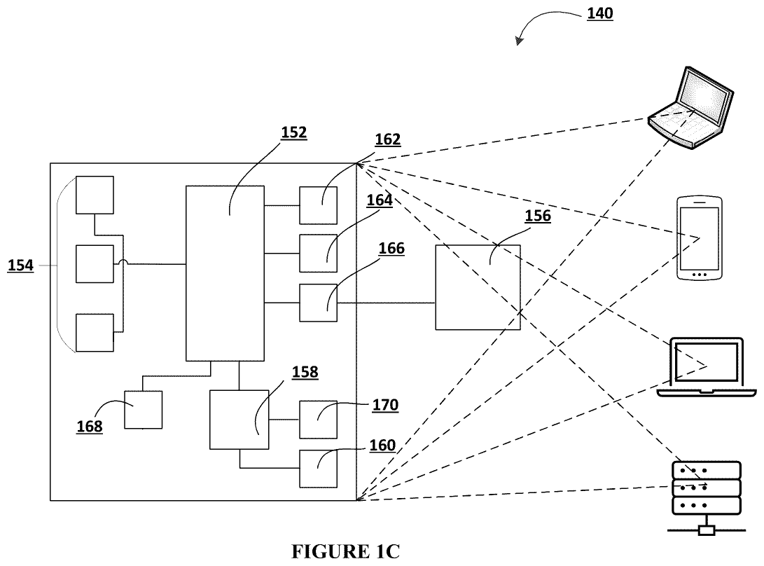

FIGS. 1A-1C illustrate technical components of an exemplary distributed computing environment for automatically rotating passwords in a multi-server environment 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

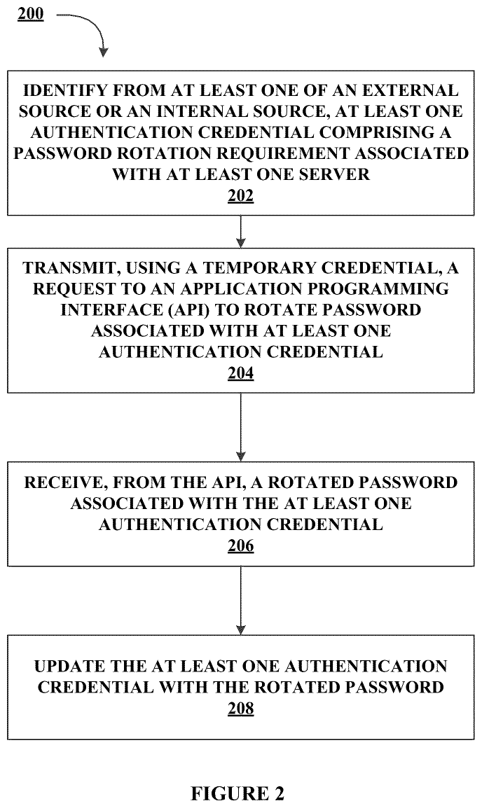

FIG. 2 illustrates the process flow 200 for automatically rotating passwords (ARP) in a multi-server environment, in accordance with an embodiment of the disclosure. In some embodiments, a system (e.g., similar to one or more of the systems described herein with respect to FIGS. 1A-1C) may perform one or more of the steps of process flow 200. For example, a system (e.g., the system 130 described herein with respect to FIG. 1A-1C) may perform the steps of process 200.

As shown in block 202, the process flow 200 may include the step of identifying from at least one of an external source or an internal source, at least one authentication credential comprising a password rotation requirement associated with at least one server. For example, the ARP system may be configured to identify authentication credentials that comprises the password rotation requirement from a source, to rotate the password associated with authentication credentials, to receive the rotated password, and to update the password within the target object and/or the metadata of the target object.

In some embodiments, the identification of the authentication credential(s) may comprise validating the existence of the target object and confirming the location information of the target object. In some embodiments, the ARP system may be configured to identify an authentication credential(s) by parsing the server(s) to extract data in the server and/or metadata of the server, parsing the data to extract metadata of the data, parsing and/or analyzing the metadata to extract authentication credentials of the target object that may comprise the password rotation requirement, and/or the like.

In some embodiments, the ARP system may be configured to identify target objects that have a password rotation requirement by scanning and parsing the nodes, the servers, and/or the systems within the multi-server network. Additionally, and/or alternatively, the ARP system may be configured to search in a metadata information storage (e.g., a database or dataset comprising the details of the metadata associated with the server, system, and/or the like) based on the authentication credentials from the source to locate the target object, where information of authentication credentials from the source does not comprise location information of the target object.

In some embodiments, an external source may comprise a user(s) access system, an external PMS, and/or an external system housed, stored, and/or managed outside the network comprising the servers requiring password rotation(s). For example, the user(s) access system may comprise an interface configuration module which may be transmitted to a user device to configure the graphical user interface (GUI) of the user device to provide an interactive platform for the user of the user device to access the multi-server network or environment. In some such embodiments, the interactive platform may comprise data and/or information in a human-readable format indicating the servers requiring a password rotation, the last password rotation implemented on each server, the associated users with authentication credentials that need password changes, and/or the like. As used herein, the multi-server environment may be a network configured to interconnect nodes and/or multiple servers. Further, and in some embodiments, the multi-server network may comprise the ARP system that provides automatic password rotating process in the multi-server network.

As used herein, the external system refers to a system external or outside of the multi-server network (e.g., such that the external system is stored outside of the multi-server network, the external system is operated and/or managed outside of the multi-server network, and/or the like). Such an external system may comprise data, a system, and/or service that provides information on authentication credentials that comprise password rotation requirements associated with the target object in the multi-server network.

In some embodiments, a password management system (PMS) may be configured to provide controlled and secured storage to user(s) to manage the user(s)'s authentication credentials. In some such embodiments, the user(s) may store the authentication credentials with or without a location of target object based on the PMS's ability to locate the target objects in the multi-server network.

In some embodiments, the temporary credential(s) may comprise a token that expires its validation at a pre-defined threshold time. Such a temporary credential(s) may be generated by the PMS when requested by the user(s). In some embodiments, user(s) may use a secret identifier that is configured to request the PMS to generate the temporary credential. In some embodiments, the user(s) may transfer the temporary credentials associated with the user(s) to the ARP system, whereby the ARP system may be configured to utilize the temporary credentials to manage the user(s') authentication credentials in the PMS.

As used herein, the internal source may comprise the internal PMS, a metadata information storage, and/or any types of nodes, the servers, the systems, or the like in the multi-server network. For example, the metadata information storage may be a centralized database that stores metadata information of the authentication credentials requiring the password rotation requirements collected by the ARP system.

In some embodiments, an authentication credential may comprise location information of the target object within the multi-server network. In some embodiments, the metadata associated with the authentication credential may comprise data that provides information about the target object. In some embodiments, the PMS may be configured to provide one authentication credential to one target object. In some embodiments, the PMS may be an application program interface (API) that may be configured to offer an API Plug-in to other systems, whereby the API Plug-in connects the other system to the API allowing other systems to utilize the API's features. In some embodiments, the PMS may be internal PMS to (or stored/embedded in) the multi-server network and/or implemented in the ARP system.

In some embodiments, the target object may comprise data, a server, an application, a system, and/or the like, that an authentication process is protecting or what the user(s) is trying to gain access to using their credentials such as, a username and a password, a token(s), and/or the like.

In some embodiments, and as used herein, the muti-server network may be configured to be operated by an operating system (OS) such as Linux®, Unix®, Microsoft®, Cloud-based OS, and the like. Each OS may use its command line interface (CLI) to manage operations of the network, which may comprise management of a connection to an external source. Further, and in some embodiments, the nodes in the multi-server network may use the same OS and/or CLI to be configured to interconnect with each other. In some embodiments, as used herein, the ARP system may be configured to use the CLI to connect with the user(s) access system, the external password management system (PMS), the external system, and/or the nodes, servers and the systems comprising internal sources within the multi-server network.

As shown in block 204, the process flow 200 may include the step of transmitting, using a temporary credential, a request to an application programming interface (API) to rotate passwords associated with at least one authentication credential. In some embodiments, the API may comprise the PMS and/or may be the PMS. Further, and in such embodiments, the temporary credential may be generated by the PMS with a request from the user(s), whereby the ARP system may be configured to use the temporary credential to request the PMS rotate the stored password associated with the user(s)'s authentication credential.

Thus, and in some embodiments, identifying from at least one of an external source or an internal source, at least one authentication credential comprising a password rotation requirement may comprise the ARP system finding one or more authentication credentials that comprise the password rotation requirement from the (external and/or internal) source, to locate the target object in the multi-server network, and/or to validate the existence of the authentication credential. In some embodiments, the user(s) may send a temporary credential generated by the PMS to the ARP system through the user(s) access system, whereby the ARP system may be configured to receive the metadata of authentication credentials associated with the user(s) by transmitting the temporary credential with the request to the PMS. Further, and in some embodiments, the ARP system may be configured to search the metadata information storage to supplement the location information of the target, where the authentication credential from the metadata received from the PMS is missing the location information, such that the ARP system may be configured to locate and/or to validate the existence of the target object.

In some embodiments, the PMS may be configured to rotate the stored password, to transmit the stored password, or transmit the metadata of the user(s)' authentication credentials upon request with a temporary credential associated with the user(s). In some embodiments, the temporary credential(s) may comprise a token that expires its validation at a pre-defined threshold time. Such a temporary credentials may be generated by the PMS when requested by the user(s). In some embodiments, user(s) may utilize a secret identifier that is configured to request the PMS to generate the temporary credential. In some embodiments, the user(s) may transfer the temporary credentials associated with the user(s) to the ARP system, whereby the ARP system may be configured to use the temporary credentials to manage the user(s)'s authentication credentials in the PMS.

As shown in block 206, the process flow 200 may include the step of receiving, from the API, a rotated password associated with the at least one authentication credential. For example, the ARP system may be configured to receive the rotated password associated with the authentication credential from the PMS. In some embodiments, the ARP system may be configured to request, using the temporary credential associated with the user(s), the rotated password associated with the user(s)'s authentication credential. In some embodiments, the API may analyze a database of previously used passwords and/or authentication credentials before generating the updated password, which may allow for a more secure and brand new password to be used for the server(s).

As shown in block 208, the process flow 200 may include the step of updating the at least one authentication credential with the rotated password. For example, the ARP system may be configured to update the authentication credential of the target object with the rotated password received from the PMS. Such an authentication credential may be located during the identifying process. For instance, and in some embodiments, the PMS may be further configured to rotate the passwords at a pre-defined period when the PMS locates the target object and/or metadata of the target object. Additionally, and/or alternatively, the PMS may be configured to rotate the stored password upon request from the user(s) through the user access system. Further, the PMS may be configured to rotate the stored password, to transmit the stored password, or transmit the metadata of the user(s') authentication credentials upon request with a temporary credential associated with the user(s). In some embodiments, the external PMS refers the PMS out of the muti-server network such that the external PMS operates independently from the multi-server network. In some embodiments, and as described in further detail hereinbelow, the process for updating the passwords may change based on the server type associated with each password rotation requirement (e.g., always on availability group, specific use server, and/or the like).

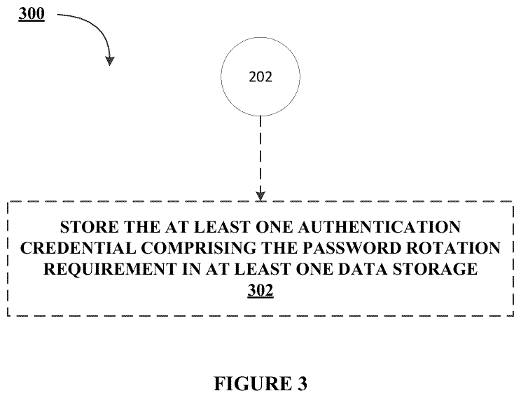

FIG. 3 illustrates a process flow 300 for collecting metadata information of authentication credentials in a multi-server network, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300.

As shown in block 302, the process flow 300 may include the step of storing the at least one authentication credential comprising the password rotation requirement in at least one data storage. In some embodiments, and as shown herein, the process described herein with respect to block 302 may follow the processes described hereinabove with respect to block 202. For example, and in some embodiments, the ARP system may be configured to identify authentication credentials that comprises the password rotation requirement from the source and to store the authentication credentials and metadata of authentication credentials associated with the target object in a storage.

In some such embodiments, the ARP system may be configured to store the authentication credentials and metadata of authentication credentials associated with the target object in the multi-server network. As used herein, metadata of authentication credentials may comprise the location information of the target object, such as logins of target objects, entitlement information, connection information of servers, database, login, and provider, and/or the like. In some embodiments, metadata of the authentication credentials may be stored in a centralized database, such as metadata information storage, thereby the ARP system may be configured to use the centralized database to locate the target objects in the multi-server network when the metadata of the user(s') authentication credentials from the external source, such as the PMS, is missing the location information. Thus, and in such embodiments, the ARP system may process the password rotation by skipping the identification process for the target objects in the multi-server network. In some embodiments, the ARP system may be configured to scan the nodes, servers, and/or systems in the multi-server network to update the centralized database.

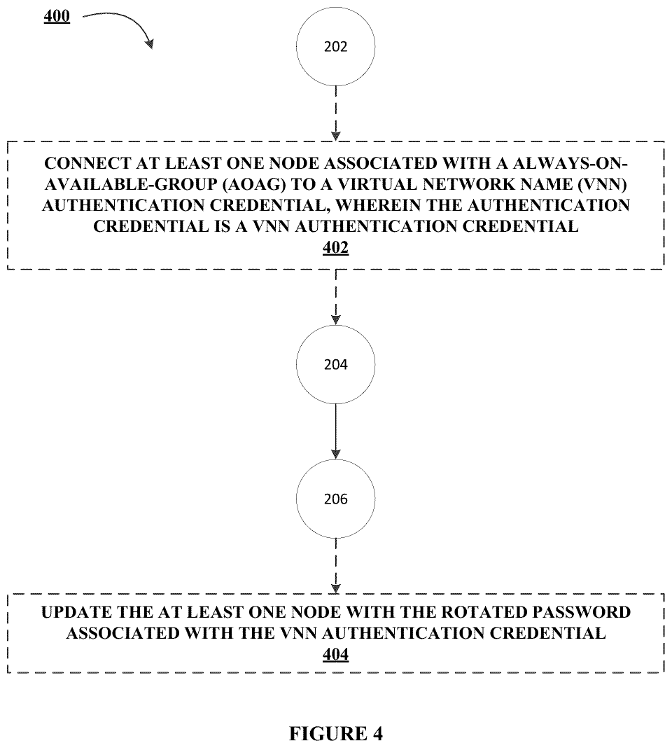

FIG. 4 illustrates a process flow 400 for the password rotating process of a high availability cluster by the ARP system, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400.

As shown in block 402, the process flow 400 may include the step of connecting at least one node associated with an always-on-available-group (AOAG) to a virtual network name (VNN) authentication credential, wherein the authentication credential is the VNN authentication credential. In some embodiments, and as shown herein, the process described herein with respect to block 402 may follow the processes described hereinabove with respect to block 202. In some embodiments, and as shown herein, the process described herein with respect to block 402 may precede the processes described hereinabove with respect to block 204. In some embodiments, and as shown herein, the process described herein with respect to block 404 may follow the processes described hereinabove with respect to block 206.

For example, and in some such embodiments, the ARP system may be configured to identify the authentication credentials that need password rotation associated with the target object associated with the VNN and the AOAG from the source. Then, the ARP system may be configured to check the target objects in AOAG and validate the target objects are all connected, whereby the ARP system may be configured to transmit, using a temporary credential, a request to PMS to rotate the password associated with the target objects. Further, the ARP system may be configured to receive the rotated password from the PMS, whereby the ARP system may be configured to update the password associated with the target object within the VNN and/or AOAG.

In some embodiments, the AOAG may be a system comprising a group of multiple servers that work as a single system. In some embodiments, the AOAG may be a high availability cluster. As used herein, a high availability cluster may be a system designed to operate continuously without failure for any period of time, for long periods (e.g., a few seconds, less than one second, a few milliseconds, a minute, an hour, and/or the like), whereby the continuous operation ensures services and applications remain accessible in the event of hardware, software, and/or network failures. As used herein, a cluster may comprise a group of multiple servers that are configured to work as a single system to offer high availability. For example, when one server in the cluster fails, one or more other servers may take over the load to ensure high/continuous availability. In some embodiments, the high availability cluster may be an Always-On-Availability-Groups (AOAG)™ from Microsoft Structured Query Language (MSSQL)®, Oracle Real Application Clusters™ from Oracle®, Db2® High Availability Disaster Recovery (HADR) from IBM®, and/or the like.

In some embodiments, and as used herein, the VNN is a network name that is not tied to a specific physical server or node within the cluster. Such a VNN is associated with a virtual IP address that can be moved between different servers or nodes in the cluster. For example, the VNN that is connected to a primary server in the high availability cluster may switch connection to a secondary replica server when the primary server fails to operate. In some embodiments, the user(s) may use the VNN to access the high availability cluster without needing to know the physical server hosting the service. In some embodiments, the VNN may be configured to request the VNN authentication credential to user(s) to allow access to the high availability cluster such as AOAG. In some embodiments, the VNN may be a listener in AOAG from (MSSQL)®.

Importantly, and in some embodiments, the PMS may be configured such that it could not individually recognize each server within the high availability cluster, due to constraints or limitations in the PMS configuration (e.g., constraints on the API framework that the constraints described above in the Background section). Further, the PMS may be configured to only provide one authentication credential(s) to one target object, whereby limiting user(s) to use the shared authentication credential to each of the nodes within the high availability cluster to work as a single system. In some embodiments, and as used herein, the PMS may be configured to recognize the VNN as the target object. In some embodiments, the ARP system may be configured to establish a connection among all nodes within the high availability cluster that require password rotation with the shared authentication credentials. Additionally, the ARP system may further be configured to update the nodes that shares the authentication credentials with the VNN authentication credentials upon the rotation of the VNN authentication credentials by the PMS.

For example, the ARP system may be configured to identify authentication credentials that need password rotation associated with the VNN and the AOAG from the metadata of user(s)'s authentication credentials received from the PMS in the step of 202. In such embodiments, the identified authentication credential is the VNN authentication credential that comprises information for the PMS to identify the target object. In some embodiments, and with respect to block 402, the ARP system may be configured to connect to AOAG associated with the VNN, check the connectivity of the nodes that may share the same authentication credential with the VNN, and verify the connection. Further, the ARP system may be configured to receive port numbers of the nodes upon the verification that all connections have been successfully established. Then, and in such embodiments, the ARP system may be configured to transmit the request to the PMS to rotate the password associated the VNN authentication credentials using the temporary credential as shown in block 204. The PMS may update the authentication credential of the VNN as the PMS may recognize the VNN using the metadata of the user(s)'s authentication credential. Subsequently, the ARP system may be configured to receive the rotated password associated with the VNN authentication credential using the temporary credential from the PMS as shown in block 206.

As shown in block 404, the process flow 400 may include the step of updating the at least one node with the rotated password associated with the VNN authentication credential. In some embodiments, the ARP system may be configured to update the VNN authentication credential to the nodes in the AOAG using the port number received during the verification of the node connection.

In some embodiments, the ARP system may be configured to terminate the process and, in each step of the process flow 400, transmit an error code and/or an error report to a user managing the ARP system when the process is not completed. For example, in the step of the block 402, the ARP system may be configured to terminate the process and to transmit an error code with the error report when all the connection to the node is not verified. In some embodiments, the ARP system may be configured to transmit a success code and a success report to a user managing the ARP system when the process is completed.

In some embodiments, the multi-server network may comprise multiple AOAGs and associated VNNs that require password rotations. The ARP system may be configured to operate the password rotation process for the AOAGs and the VNNs, sequentially, and/or in parallel.

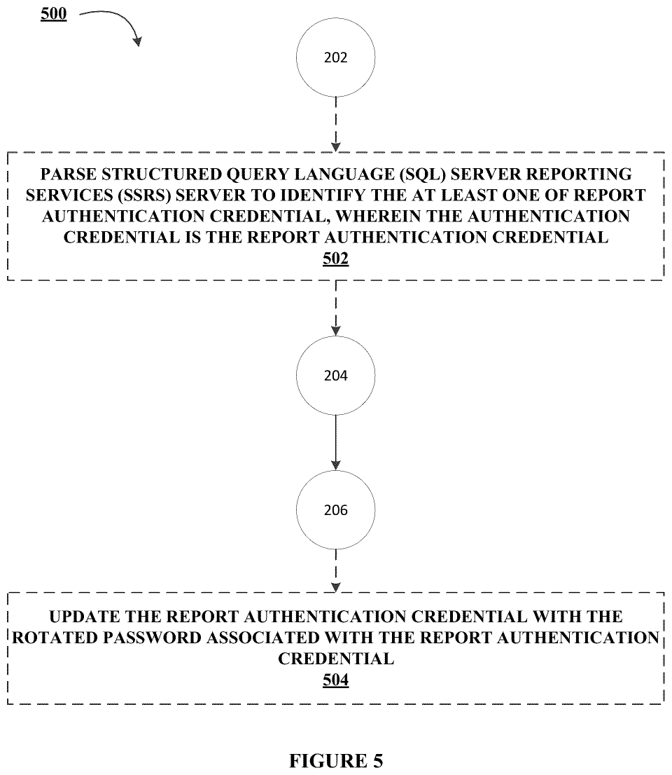

FIG. 5 illustrates a process flow 500 for the password rotating process of the SQL Server Reporting Services (SSRS) server by the ARP system, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500.

As shown in block 502, the process flow 500 may include the step of parsing an SSRS server to identify the at least one of report authentication credential, wherein the authentication credential is the report authentication credential. In some embodiments, and as shown herein, the process described herein with respect to block 502 may follow the processes described hereinabove with respect to block 202. In some embodiments, and as shown herein, the process described herein with respect to block 502 may precede the processes described hereinabove with respect to block 204. In some embodiments, and as shown herein, the process described herein with respect to block 504 may follow the processes described hereinabove with respect to block 206.

For example, and in some such embodiments, the ARP system may be configured to identify the authentication credentials that need password rotation associated with the target object within the SSRS server from the source. Then, the ARP system may be configured to parse the SSRS server to locate the target object within the SSRS server, whereby the ARP system may be configured to transmit, using a temporary credential, a request to PMS to rotate the password associated with the target object and authentication credentials within the SSRS server. Further, the ARP system may be configured to receive the rotated password from the PMS, whereby the ARP system may be configured to update the password associated with the target object.

In some embodiments, the SSRS server may be a part of a cluster of specific server types (e.g., Business Intelligence (BI) server). For instance, the SSRS and other such specific servers may be configured to carry out a specific or particular function of an entity associated with the network that manages and/or operates the BI servers and/or the SSRS server. In some such embodiments, a BI server refers to a specialized server or software platform configured to host, manage, and deliver business intelligence applications and services. Such BI servers are critical components for organizations that rely on data analysis, reporting, and decision-making tools to derive insights from their data. In some embodiments, the SSRS server may be configured as a server-based report generation software system. The SSRS server may be used for creating, deploying, and/or managing report(s) for the user(s). In some embodiments, such a report may require a report authentication credential to access the report, and thus, each report may be configured with a password rotation requirement.

In some embodiments, and as used herein, the PMS may be configured such that it may not recognize the reports within the SSRS server, due to the constraints or the limitations in the PMS configuration. In some embodiments, the user(s) may generate the report authentication credential for each of the reports within the SSRS server and store the passwords in the PMS. The PMS, however, may not rotate the password as the PMS is unable to recognize the target object associated with the password (e.g., the reports generated by the SSRS). In some embodiments, the ARP system may be configured to identify reports and the associated report authentication credentials within the SSRS server. Further, the ARP system may be configured to match the report authentication credentials within the SSRS server with the user(s') report authentication credentials stored in the PMS, whereby enabling the ARP system to manage the rotation of the password.

For example, and in some such embodiments, the ARP system may be configured to identify authentication credentials that need password rotation associated with the report within the SSRS server from the metadata of the user(s)'s authentication credentials received from the PMS in the step of block 202. In some such embodiments, the identified authentication credential may be the report authentication credential, but the PMS may be unable to recognize the target object. In some embodiments, and with respect to block 502, the ARP system may be configured to parse the SSRS server to identify the report and the associated report authentication credentials. In some embodiments, the ARP system may be configured to parse a Windows Management Instrumentation (WMI), which may be embedded in the SSRS server, to extract Uniform Resource Locator (URL) which may comprise the location of the report. Such a report may be located within a sub-server of the SSRS server. Subsequently, the ARP system may be configured to locate the report, and to parse the report to identify the report authentication credentials.

Thereafter, the ARP system may be configured to transmit the request to the PMS to rotate the password associated with the report authentication credentials using the temporary credential as shown in block 204. Then, the ARP system may be configured to receive the rotated password associated with the report authentication credential using the temporary credential from the PMS as shown in block 206.

As shown in block 504, the process flow 500 may include the step of updating the report authentication credential with the rotated password associated with the report authentication credential. For example, the ARP system may be configured to update the rotated password to the target objects by using the location information of the target object found during the identifying process in block 502 (e.g., identifying each of the reports, and their authentication credentials).

In some embodiments, the ARP system may be configured to identify the report in the SSRS server by searching in the metadata information storage, based on the authentication credentials from the PMS, comprising information of the location for the report and/or authentication credentials in SSRS server, wherein the ARP system may be configured to locate the report and/or the authentication credentials based on the location information from the metadata information storage. Further, and in some such embodiments, the ARP system may be configured to collect the authentication credentials and/or the metadata of the authentication credentials in the SSRS server, whereby the ARP system may be configured to update the metadata information storage.

In some embodiments, the ARP system may be configured to terminate the process and, in each step of the process flow 500, transmit an error code and an error report to a user managing the ARP system when the process is not completed. For example, the ARP system may be configured to terminate the process when transmitting a request to rotate the password to the PMS has failed due to the bad connection between the PMS and the ARP system, whereby the ARP system may be configured to transmit the error code and the error report associated with bad connection to the PMS. In some embodiments, the ARP system may be configured to transmit a success code and a success report to a user managing the ARP system when the process is completed.

In some embodiments, the SSRS server may comprise multiple reports within the server. The ARP system may be configured to repeat the parsing process until all reports are identified. Upon completion of the previous step, the ARP system may be configured to operate the password rotation process for each of the identified reports, sequentially and/or parallelly. In some embodiments, the multi-server network may comprise multiple SSRS servers that may comprise the reports. The ARP system may be configured to operate the password rotation process for each of the SSRS servers, sequentially and/or parallelly.

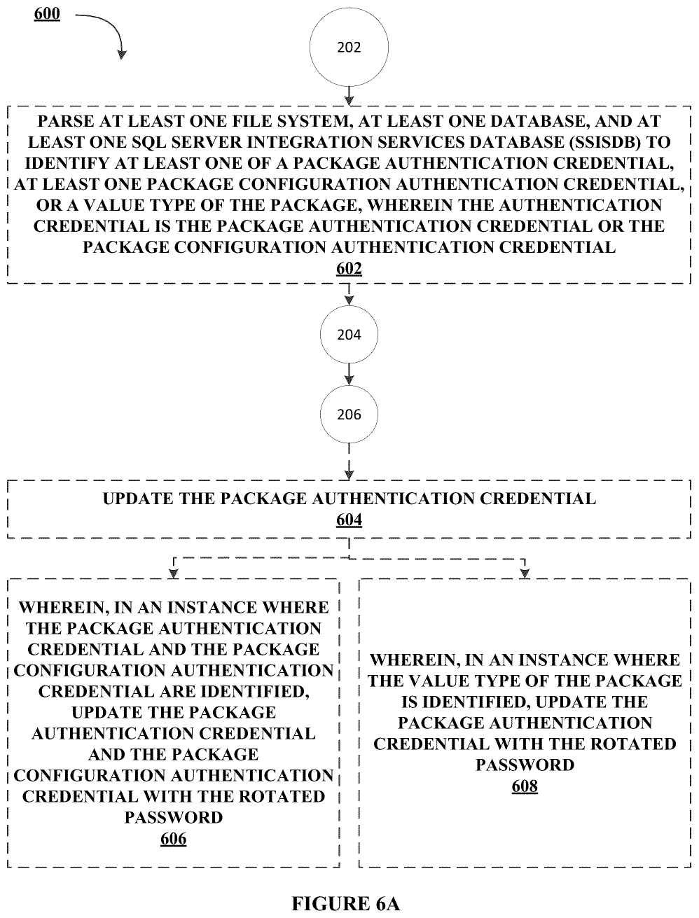

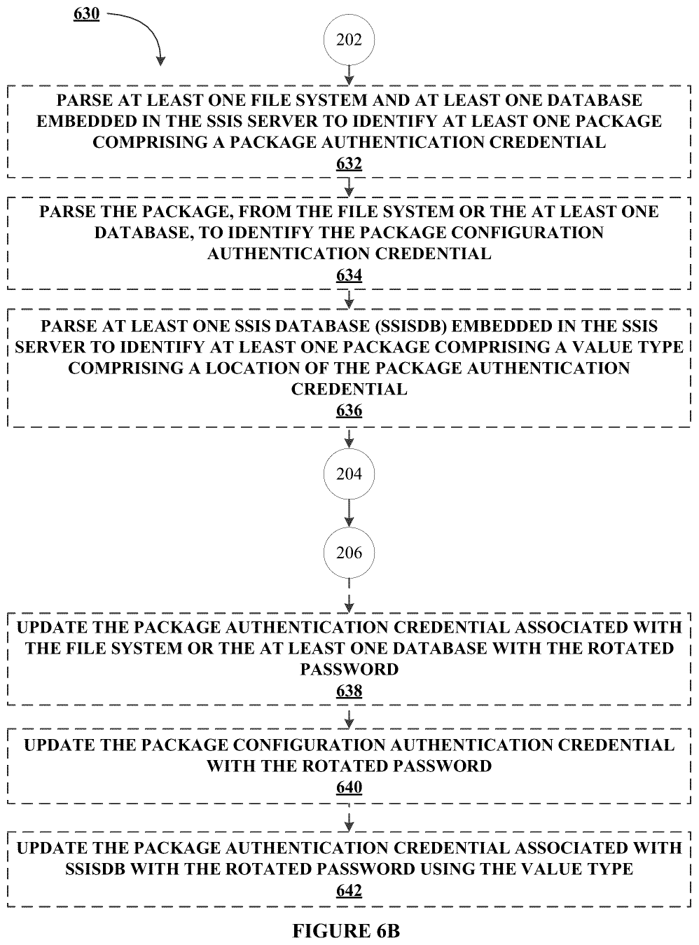

FIG. 6A illustrates a process flow 600 for the password rotating process of the SQL Server Integration Services (SSIS) server by the ARP system, in accordance with an embodiment of the disclosure. In some embodiments, a system (e.g., similar to one or more of the systems described herein with respect to FIGS. 1A-1C) may perform one or more of the steps of process flow 600. For example, a system (e.g., the system 130 described herein with respect to FIG. 1A-1C) may perform the steps of process 600.

As shown in block 602, the process flow 600 may include the step of parsing at least one file system, at least one Database, and at least one SSIS Database (SSISDB) to identify at least one of a package authentication credential, at least one package configuration authentication credential, or a value type of the package, wherein the authentication credential is the package authentication credential or the package configuration authentication credential. In some embodiments, and as shown herein, the process described herein with respect to block 602 may follow the processes described hereinabove with respect to block 202. In some embodiments, and as shown herein, the process described herein with respect to block 602 may precede the processes described hereinabove with respect to block 204. In some embodiments, and as shown herein, the process described herein with respect to block 604 may follow the processes described hereinabove with respect to block 206.

For example, and in some such embodiments, the ARP system may be configured to identify the authentication credentials that need password rotation associated with the target object within the SSIS server from the source. Then, the ARP system may be configured to parse the SSIS server to locate the target object credentials within the SSIS server, whereby the ARP system may be configured to transmit, using a temporary credential, a request to the PMS to rotate the password associated with the target object and authentication credentials within the SSIS server. Further, the ARP system may be configured to receive the rotated password from the PMS, whereby the ARP system may be configured to update the password associated with the target object.

In some embodiments, the SSIS server may be part of a cluster of the BI servers. For instance, the SSIS and other such specific servers may be configured to carry out a specific or particular function of an entity associated with the network that manages and/or operates the BI servers and/or the SSIS server. Such BI servers are critical components for organizations that rely on data analysis, reporting, and decision-making tools to derive insights from their data.

Such an SSIS server may be used to manage complex data integration tasks and workflows, such as data integration, transformation, and migration. In some embodiments, the SSIS server may be used to automate the extraction, transformation, and loading of data across different sources and destinations using a package. As used herein, the package refers to a fundamental unit of work within the SSIS server that encapsulates the control flow and data flow necessary for executing tasks, managing data, and automating processes. In some embodiments, such a package may require a package authentication credential and a package configuration authentication credential to access, whereby the package may be configured with the password rotation requirements.

In some embodiments, the ARP system may be configured to identify packages and the associated package authentication credentials and/or the package configuration authentication credentials within the SSIS server. Further, the ARP system may be configured to match the package authentication credentials and the package configuration authentication credentials within the SSIS server with the user(s') package authentication credentials and the package configuration authentication credentials stored in the PMS, whereby enabling the ARP system to manage the rotation of the password. For example, and in some such embodiments, the ARP system may be configured to identify authentication credentials that need a password rotation associated with the package within the SSIS server from the metadata of the user(s)' authentication credentials received from the PMS in the step of block 202. Thus, and in some such embodiments, the identified authentication credential is the package authentication credential and/or the package configuration authentication credential, but the PMS may be unable to recognize the target object.

In some embodiments, and with respect to block 602, the ARP system may be configured to parse the SSIS server to identify the package and the associated authentication credentials. In some embodiments, the ARP system may be configured to parse at least one File System, at least one Database (e.g., a Microsoft database or “MSDB”), and/or at least one SSISDB, embedded in the SSIS server, to identify the packages. In some embodiments, and in the case where the package is identified from the File System and/or the Database, the package may be an Extensible Markup Language (XML) file, whereby the package may comprise configuration information in a configuration file that may be configured to require package configuration authentication credentials to access. The ARP system may further be configured to parse the package to extract the package authentication credentials and the configuration file to extract the package configuration authentication credentials. In the case where the package is identified from the SSISDB, the package may comprise the value type of the package. Such a value type may comprise the location information of the password associated with the package. For example, the password of the package may be stored in an Object Parameter table when the value type is “V” or in an Environment Variable table when the value type is “R”. Thus, the ARP system may be configured to parse the package from the SSISDB and check the value type to extract the package authentication credentials from the correct location (e.g., Object Parameter table vs. Environment Variable table). Such a value type may be used in a later process when updating the rotated password.

In some embodiments, and as used herein, the PMS may be configured such that the PMS may not recognize the packages within the SSIS server, due to the constraints or the limitations in the system configuration. In some embodiments, the user(s) may generate the package authentication credential and the package configuration authentication credential for each of the packages within the SSIS server and store the passwords in the PMS. The PMS, however, may not rotate the password as the PMS may be unable to recognize the target object associated with the password due to the constraints or the limitations in the PMS configuration to parse the SSIS server.

Thereafter, and in some such embodiments, the ARP system may be configured to transmit the request to the PMS to rotate the password associated with the package authentication credentials and/or the package configuration authentication credentials using the temporary credential as shown in block 204. Then, the ARP system may be configured to receive the rotated password associated with the package authentication credentials and/or the package configuration authentication credentials using the temporary credential from the PMS as shown in block 206.

As shown in block 604, the process flow 600 may include the step of updating the package authentication credential. For instance, and in some embodiments, in an instance where the package authentication credential and the package configuration authentication credential are identified, update the package authentication credential and the package configuration authentication credential with the rotated password (as shown in block 606). For example, the ARP system may be configured to update the package authentication credentials and the package configuration authentication credentials with the rotated password in the File System or the Database within the SSIS server because the package authentication credentials and the package configuration authentication credentials are both identified.

As shown in block 604, the process flow 600 may include the step of updating the package authentication credential. For instance, and in some embodiments, in an instance where the value type of the package is identified, update the package authentication credential with the rotated password (as shown in block 608). For example, the ARP system may be configured to update the package authentication credentials with the rotated password in the SSISDB in the correct table, because the package authentication credentials contain the value type of the package.

In some embodiments, the ARP system may be configured to identify the package in the SSIS server by searching in the metadata information storage, based on the authentication credentials from the PMS, comprising information of the location for the package and/or authentication credentials associated with the package in SSIS server, wherein the ARP system may be configured to locate the package and/or the authentication credentials associated with the package based on the location information from the metadata information storage. Further, in some such embodiments the ARP system may be configured to collect the authentication credentials and/or the metadata of authentication credentials in the SSIS server, whereby the ARP system may be configured to update the metadata information storage.

In some embodiments, the ARP system may be configured to terminate the process and, in each step of the process flow 600, to transmit an error code and an error report to a user managing the ARP system when the process is not completed. In some embodiments, the ARP system may be configured to transmit a success code and a success report to a user managing the ARP system when the process is completed.

In some embodiments, the SSIS server may comprise multiple packages within the server. The ARP system may be configured to repeat the parsing process until all packages are identified. Upon completion of the previous step, the ARP system may be configured to operate the password rotation process for each of the identified packages, sequentially and/or parallelly. In some embodiments, the multi-server network may comprise multiple SSIS servers that may comprise the packages. The ARP system may be configured to operate the password rotation process for each of the SSIS servers, sequentially and/or parallelly.

FIG. 6B illustrates a process flow 630 for the password rotating process of the SQL Server Integration Services (SSIS) server by the ARP system, in accordance with an embodiment of the disclosure. In some embodiments, a system (e.g., similar to one or more of the systems described herein with respect to FIGS. 1A-1C) may perform one or more of the steps of process flow 630. For example, a system (e.g., the system 130 described herein with respect to FIG. 1A-1C) may perform the steps of process 630. The process flow 630 is substantially similar to the process flow 630 but is illustrated in a different manner.

As shown in block 632, the process flow 630 may include the step of parsing at least one file system and at least one database embedded in the SSIS server to identify at least one package comprising a package authentication credential. In some embodiments, and as shown herein, the process described herein with respect to block 632 may follow the processes described hereinabove with respect to block 202. In some embodiments, and as shown herein, the process described herein with respect to block 632 may precede the processes described hereinabove with respect to block 204. In some embodiments, and as shown herein, the process described herein with respect to block 634 may follow the processes described hereinabove with respect to block 206.

For example, and in some such embodiments, the ARP system may be configured to identify the authentication credentials that need password rotation associated with the target object within the SSIS server from the source. Then, the ARP system may be configured to parse the SSIS server to locate the target object within the SSIS server, whereby the ARP system may be configured to transmit, using a temporary credential, a request to the PMS to rotate the password associated with the target object and authentication credentials within the SSIS server. Further, the ARP system may be configured to receive the rotated password from the PMS, whereby the ARP system may be configured to update the password associated with the target object.

In some such embodiments, the package refers to a fundamental unit of work within the SSIS server that encapsulates the control flow and data flow necessary for executing tasks, managing data, and automating processes. In some embodiments, such a package may require a package authentication credential and a package configuration authentication credential to access, whereby the package may be configured with the password rotation requirements.

In some such embodiments, the ARP system may be configured to identify authentication credentials that need password rotation associated with the package within the SSIS server from the metadata of the user(s') authentication credentials received from the PMS in the step of block 202. Thus, and in some such embodiments, the identified authentication credential is the package authentication credential or the package configuration authentication credential, but the PMS may be unable to recognize the target object.

In some embodiments, and with respect to block 632, the ARP system may be configured to parse the SSIS server to identify the package and the associated authentication credentials. In some embodiments, the ARP system may be configured to parse at least one File System, and at least one Database (e.g., MSDB), embedded in the SSIS server, to identify the packages.

As shown in block 634, the process flow 630 may include the step of parsing the package, from the file system or the at least one database, to identify the package configuration authentication credential. For example, in the case where the package is identified from the File System and/or the Database, the package may be the XML file, whereby the package may comprise configuration information in a configuration file that may be configured to require package configuration authentication credentials to access. The ARP system may further be configured to parse the package to extract the package authentication credentials and the configuration file to extract the package configuration authentication credentials.

As shown in block 636, the process flow 630 may include the step of parsing at least one SSIS database (SSISDB) embedded in the SSIS server to identify at least one package comprising a value type comprising a location of the package authentication credential. In some embodiments, the ARP system may be configured to parse at least one SSISDB, embedded in the SSIS server, to identify the packages. In the case where the package is identified from the SSISDB, the package may comprise the value type of the package. Such a value type may comprise the location information of the password associated with the package. For example, the password of the package may be stored in an Object Parameter table when the value type is “V” or in an Environment Variable table when the value type is “R”. Thus, the ARP system may be configured to parse the package from the SSISDB and check the value type to extract the package authentication credentials from the correct location (e.g., Object Parameter table vs. Environment Variable table). Such a value type may be used in a later process when updating the rotated password.

In some embodiments, and as used herein, the PMS may be configured such that the PMS may not recognize the packages within the SSIS server, due to the constraints or the limitations in the PMS configuration. In some embodiments, the user(s) may generate the package authentication credential and the package configuration authentication credential for each of the packages within the SSIS server and store the passwords in the PMS. The PMS, however, may not rotate the password as it is unable to recognize the target object associated with the password due to the constraints or the limitations in the PMS configuration to parse the SSIS server.

Thereafter, and in some such embodiments, the ARP system may be configured to transmit the request to the PMS to rotate the password associated with the package authentication credentials and/or the package configuration authentication credentials using the temporary credential as shown in block 204. Then, the ARP system may be configured to receive the rotated password associated with the package authentication credentials and/or the package configuration authentication credentials using the temporary credential from the PMS as shown in block 206.

As shown in block 638, the process flow 600 may include the step of updating the package authentication credential associated with the file system or the at least one database with the rotated password. For example, the ARP system may be configured to update the package authentication credentials in the File System and/or the Database within the SSIS server with the rotated password.

As shown in block 640, the process flow 600 may include the step of updating the package configuration authentication. For example, the ARP system may be configured to update the package configuration authentication credentials with the rotated password in the File System and/or the Database within the SSIS server found during the identification process described in block 636.

As shown in block 642, the process flow 600 may include the step of updating the package authentication credential. Wherein, in an instance where the value type of the package is identified, update the package authentication credential with the rotated password. For example, the ARP system may be configured to update the package authentication credentials in the SSISDB in the correct table, because the package authentication credentials comprise the value type of the package found during the identification process in block 636.

In some embodiments, the ARP system may be configured to identify the package in the SSIS server by searching in the metadata information storage, based on the authentication credentials from the PMS, comprising information of the location for the package and/or authentication credentials associated with the package in the SSIS server, wherein the ARP system may be configured to located the package and/or the authentication credentials associated with the package based on the location information from the metadata information storage. Further, and in some such embodiments, the ARP system may be configured to collect the authentication credentials and/or the metadata of authentication credentials in the SSIS server, whereby the ARP system may be configured to update the metadata information storage.

In some embodiments, the ARP system may be configured to terminate the process and, in each step of the process flow 600, transmit an error code and an error report to a user managing the ARP system when the process is not completed. In some embodiments, the ARP system may be configured to transmit a success code and a success report to a user managing the ARP system when the process is completed.

In some embodiments, the SSIS server may comprise multiple packages within the server. The ARP system may be configured to repeat the parsing process until all packages are identified. Upon completion of the previous step, the ARP system may be configured to operate the password rotation process for each of the identified packages, sequentially and/or parallelly. In some embodiments, the multi-server network may comprise multiple SSIS servers that may comprise the packages. The ARP system may be configured to operate the password rotation process for each of the SSIS servers, sequentially and/or parallelly.

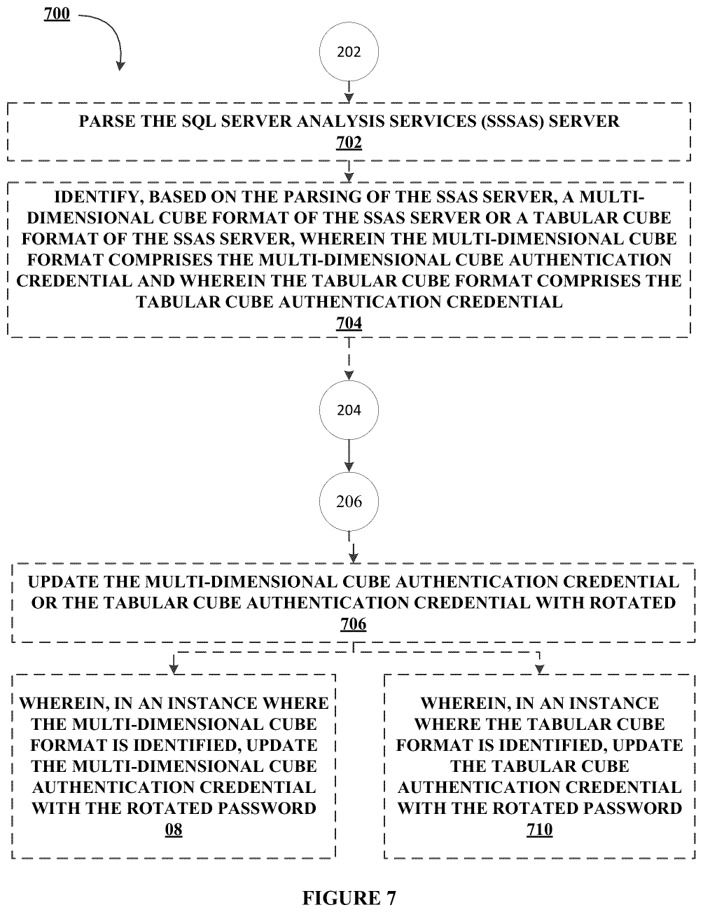

FIG. 7 illustrates a process flow 700 for the password rotating process of the SQL Server Analysis Services (SSAS) server by the ARP system, in accordance with an embodiment of the disclosure. In some embodiments, a system (e.g., similar to one or more of the systems described herein with respect to FIGS. 1A-1C) may perform one or more of the steps of process flow 700. For example, a system (e.g., the system 130 described herein with respect to FIG. 1A-1C) may perform the steps of process 700.

As shown in block 702, the process flow 700 may include the step of parsing the SSAS server. In some embodiments, and as shown herein, the process described herein with respect to block 702 may follow the processes described hereinabove with respect to block 202. In some embodiments, and as shown herein, the process described herein with respect to block 702 may precede the processes described hereinabove with respect to block 204. In some embodiments, and as shown herein, the process described herein with respect to block 704 may follow the processes described hereinabove with respect to block 206.

For example, and in some such embodiments, the ARP system may be configured to identify the authentication credentials that need password rotation associated with the target object within the SSAS server from the source. Then, the ARP system may be configured to parse the SSAS server to locate the target object within the SSAS server, whereby the ARP system may be configured to transmit, using a temporary credential, a request to PMS to rotate the password associated with the target object and authentication credentials within the SSAS server. Further, the ARP system may be configured to receive the rotated password from the PMS, whereby the ARP system may be configured to update the password associated with the target object.

As used herein, the SSAS server may be a part of the Business Intelligence (BI) servers. Such a server may be configured to provide a platform for complex data analysis, comprising online analytical processing (OLAP), tabular modeling, and/or data mining. In some embodiments, user(s) may use the SSAS server to create multi-dimensional cubes or tabular models for the purpose of analyzing data and deriving insights from large datasets. In some embodiments, the SSAS server may be configured to operate with a data model, which may be either a multi-dimensional cube or a tabular model. In some embodiments, and as described herein, the SSAS server may comprise target objects configured to require the authentication credentials to access. Such an authentication credentials may vary based on the data model, wherein, as described herein, the authentication credential may be a multi-dimensional cube authentication credential for the SSAS server using the multi-dimensional cube model, and a tabular cube authentication credential for the SSAS server using the tabular model.

In some embodiments, and as described briefly above for the shortcomings of an API, the PMS may not recognize the target objects within the SSIS server, due to the constraints or the limitations in the PMS configuration. In some embodiments, the user(s) may generate the multi-dimensional cube authentication credential or the tabular cube authentication credential depending on the data model that SSAS server uses and may store the password in the PMS. The PMS, however, may not rotate the password as the PMS may be unable to recognize the target object associated with the password. In some embodiments, the ARP system may be configured to identify the target object and the associated authentication credentials within the SSAS server. Further, the ARP system may be configured to match the multi-dimensional cube authentication credential or the tabular cube authentication credentials within the SSAS server with the user(s') multi-dimensional cube authentication credentials or the tabular cube authentication credentials stored in the PMS, whereby enabling the ARP system to manage the rotation of the password.

For example, the ARP system may be configured to identify authentication credentials that need password rotation associated with the target objects within the SSAS server from the metadata of the user(s') authentication credentials received from the PMS in the step of block 202. As used herein, the identified authentication credential is the multi-dimensional cube authentication credential or the tabular cube authentication credential, but the PMS may be unable to recognize the target object within the SSAS server. In some embodiments, and with respect to block 702, the ARP system may be configured to parse the SSAS server and to search a registry of the SSAS server, whereby the ARP system may be configured to verify the data model utilized by the SSAS server.

As shown in block 704, the process flow 700 may include the step of identifying, based on the parsing of the SSAS server, a multi-dimensional cube format of the SSAS server or a tabular cube format of the SSAS server, wherein the multi-dimensional cube format comprises the multi-dimensional cube authentication credential and wherein the tabular cube format comprises the tabular cube authentication credential. For example, the ARP system may be configured to parse the SSAS server to extract the multi-dimensional cube authentication credential when the SSAS server uses multi-dimensional cube model or the tabular cube authentication when the SSAS server uses tabular model.

Thereafter, the ARP system may be configured to transmit the request to the PMS to rotate the password associated with the multi-dimensional cube authentication credentials or the tabular cube authentication credentials using the temporary credential as shown in block 204. Then, the ARP system may be configured to receive the rotated password associated with the multi-dimensional cube authentication credentials or the tabular cube authentication credentials using the temporary credential from the PMS as shown in block 206.

As shown in block 706 and 708, the process flow 700 may include the step of updating the multi-dimensional cube authentication credential or the tabular cube authentication credential, wherein, in an instance where the multi-dimensional cube format is identified, update the multi-dimensional cube authentication credential with the rotated password. For example, the ARP system may be configured to update the multi-dimensional cube authentication credentials with the rotated password within the SSAS server using the multi-dimensional cube model associated with the multi-dimensional cube authentication credentials based on the information found during the identification process in block 704.

As shown in block 706 and 710, the process flow 700 may include the step of updating the package authentication credential, wherein, in an instance where the tabular cube format is identified, update the tabular cube authentication credential with the rotated password. For example, the ARP system may be configured to update the tabular cube authentication credentials with the rotated password within the SSAS server using the tabular model associated with the tabular cube authentication credentials based on the information found during the identification process in block 704.

In some embodiments, the ARP system may be configured to identify the target object in the SSAS server by searching in the metadata information storage, based on the authentication credentials from the PMS, comprising information of the location for the target object in SSAS server, wherein the ARP system may be configured to locate the target object based on the location information from the metadata information storage. Further, in some such embodiments, the ARP system may be configured to collect the authentication credentials and/or the metadata of authentication credentials in the SSAS server, whereby the ARP system may be configured to update the metadata information storage.

In some embodiments, the ARP system may be configured to terminate the process and, in each step of the process flow 700, to transmit an error code and/or an error report to a user managing the ARP system when the process is not completed. In some embodiments, the ARP system may be configured to transmit a success code and a success report to a user managing the ARP system when the process is completed.

In some embodiments, the SSAS server may comprise multiple target objects within the server. The ARP system may be configured to repeat the parsing process until all target objects are identified. Upon completion of the previous step, the ARP system may be configured to operate the password rotation process for each of the identified target objects, sequentially and/or parallelly.

In some embodiments, the multi-server network may comprise multiple SSAS servers that may comprise the target objects. The ARP system may be configured to operate the password rotation process for each of the SSAS servers, sequentially and/or parallelly.

In some embodiments, the SSRS server, the SSIS server, and the SSAS server may be servers in (MSSQL)®.

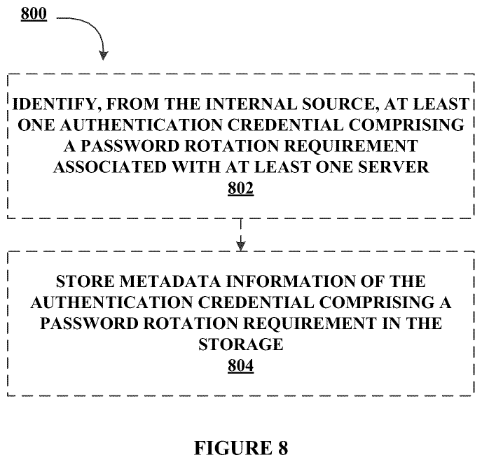

FIG. 8 illustrates a process flow 800 for collecting metadata information of authentication credentials in multi-server network, in accordance with an embodiment of the disclosure. In some embodiments, a system (e.g., similar to one or more of the systems described herein with respect to FIGS. 1A-1C) may perform one or more of the steps of process flow 800. For example, a system (e.g., the system 130 described herein with respect to FIG. 1A-1C) may perform the steps of process 800.

As shown in block 802, the process flow 800 may include the step of identifying, from the internal source, at least one authentication credential comprising a password rotation requirement associated with at least one server. For example, and in some embodiments, the ARP system may be configured to identify authentication credentials that comprise the password rotation requirement from the source and to store the authentication credentials and metadata of authentication credentials associated with the target object in a storage.

In some such embodiments, the ARP system may be configured to store the metadata of the authentication credentials associated with the target object within the servers in a multi-server network. In some embodiments, authentication credentials may comprise the report authentication credentials from the SSRS servers, the package authentication credentials and package configuration credentials from the File System and/or the Database (e.g., MSDB) within the SSIS severs, the package authentication credentials from the SSISDB within the SSIS servers, the multi-dimensional cube authentication credentials from the SSAS servers using the multi-dimensional cube model, the tabular cube authentication credentials from the SSAS servers utilizing the tabular model, and/or any other target objects, within the multi-server network that requires password rotation, that may not be identified by the PMS due to constraints or limitations in the PMS configuration.

As shown in block 804, the process flow 800 may include the step of storing metadata information of the authentication credential comprising a password rotation requirement in the storage. For example, the ARP system may be configured to store the authentication credentials and/or metadata information of authentication credentials associated with the target object in the multi-server network. As used herein, metadata information of authentication credentials may comprise the location information of the target object, such as logins of target objects, entitlement information, connection information of servers, database, login, and provider, and/or the like. In some embodiments, metadata of the authentication credentials may be stored in a centralized database, such as metadata information storage, thereby the ARP system may be configured to use the centralized database to locate the target objects in the multi-server network when the metadata of the user(s') authentication credentials from the external source, such as the PMS, is missing the location information, whereby expediting the ARP system to process the password rotation by skipping the identification process for the target objects in the multi-server network. In some embodiments, the ARP system may be configured to scan the nodes, servers, and/or systems in the multi-server network to update the centralized database.

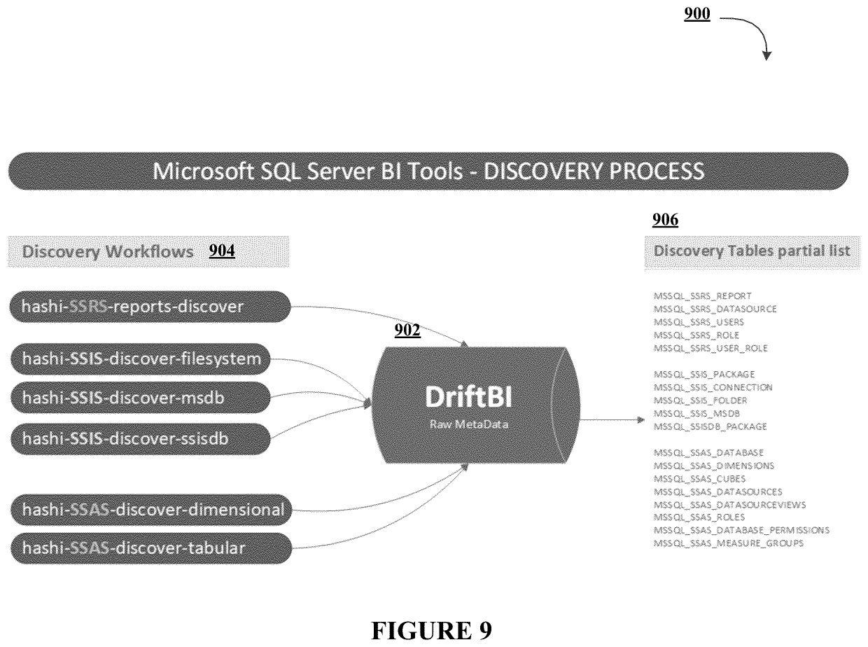

FIG. 9 illustrates a metadata collection process 900. Such a process shows the collection of metadata information of authentication credentials within the BI servers, in accordance with an embodiment of the disclosure. In some embodiments, a system (e.g., similar to one or more of the systems described herein with respect to FIGS. 1A-1C) may perform one or more of the steps of process 900. For example, a system (e.g., the system 130 described herein with respect to FIG. 1A-1C) may perform the steps of process 900.

For example, and as shown herein, DriftBI 902 may be the ARP system. Additionally, and as shown herein, list of scripts in Discovery Workflows 904 scans servers (such as but not limited to SSRS, SSIS, SSAS) to identify target objects that need password rotations. In some embodiments, the metadata information of the identified target objects are sent to the DriftBI to store the metadata information. As shown herein, Discovery Tables partial list 906 shows a partial list of the identified target objects.

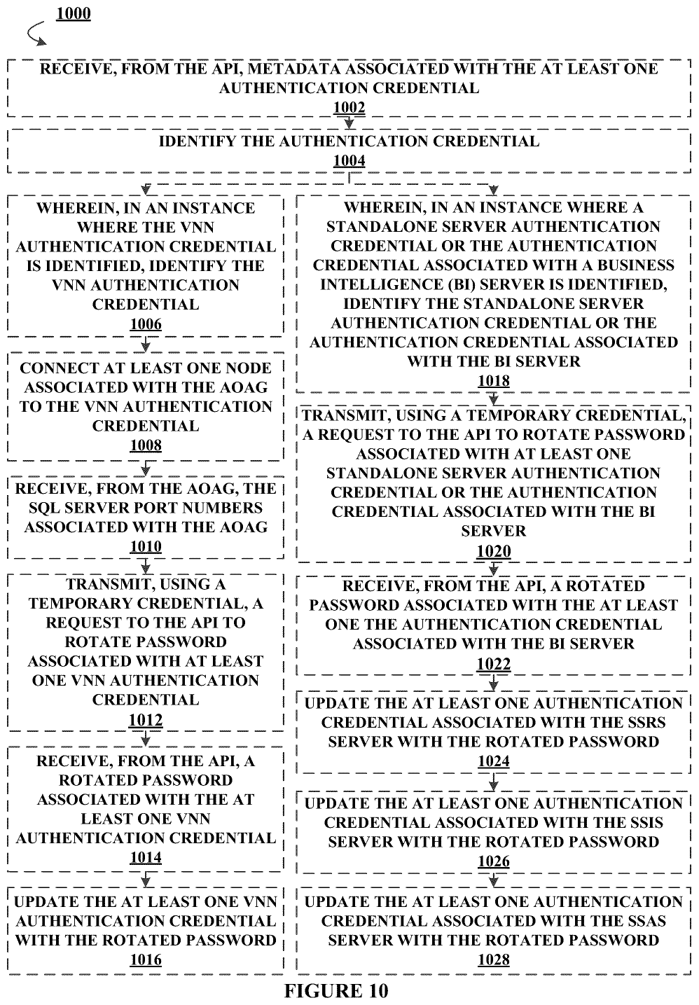

FIG. 10 illustrates a process flow 1000 for the password rotating process of the servers in a multi-server network by the ARP system, in accordance with an embodiment of the disclosure. In some embodiments, a system (e.g., similar to one or more of the systems described herein with respect to FIGS. 1A-1C) may perform one or more of the steps of process flow 1000. For example, a system (e.g., the system 130 described herein with respect to FIG. 1A-1C) may perform the steps of process 1000.

As shown in block 1002, the process flow 1000 may include the step of receiving, from the API, metadata associated with the at least one authentication credential. For example, in some embodiments, the ARP system may be configured to identify authentication credentials that comprise the password rotation requirement from the source, to rotate the password associated with authentication credentials, to receive the rotated password, and to update the password within the target object and/or the metadata of the target object.

In some embodiments, and with respect to block 1002, the ARP system may be configured to receive metadata associated with authentication credential from the API. In some embodiments, the API is the PMS, whereby the ARP system may be configured to receive, using the temporary credential associated with the user(s), metadata associated with the user(s)'s authentication credential from the PMS.

In some embodiments, the PMS may be configured to provide controlled and secured storage to user(s) to manage the user(s)'s authentication credentials. The PMS may be further configured to rotate the passwords at a pre-defined period when the PMS identifies a target object and/or metadata of the target object. Additionally, or alternatively, the PMS may be configured to rotate the stored password upon request from the user(s) through the user(s') access system. Further, the PMS may be configured to rotate the stored password, to transmit the stored password, and/or transmit the metadata of the user(s') authentication credentials upon request with a temporary credential associated with the user(s). In some embodiments, the temporary credential(s) may comprise a token that expires its validation at a pre-defined threshold time. Such a temporary credentials may be generated by the PMS when requested by the user(s). In some embodiments, user(s) may use a secret identifier that is configured to request the PMS to generate the temporary credential. In some embodiments, the user(s) may transfer the temporary credentials associated with the user(s) to the ARP system, whereby the ARP system may be configured to use the temporary credentials to manage the user(s)'s authentication credentials in the PMS.

As shown in block 1004 and 1006, the process flow 1000 may include the step of identifying the authentication credential, wherein, in an instance where the VNN authentication credential is identified, identify the VNN authentication credential. For example, the ARP system may be configured to identify authentication credentials that comprise the password rotation requirement associated with the VNN from the PMS. The ARP system may be configured to identify the AOAG associated with the VNN. In such embodiments, the identified authentication credential is the VNN authentication credential that comprises information for the PMS to identify the target object.

As shown in block 1008, the process flow 1000 may include the step of connecting at least one node associated with the AOAG to the VNN authentication credential. For example, the ARP system may be configured to connect to AOAG associated with the VNN, check the connectivity of the nodes that may share the same authentication credential with the VNN, and verify the connection.

As shown in block 1010, the process flow 1000 may include the step of receiving, from the AOAG, the SQL server port numbers associated with the AOAG. For example, the ARP system may be configured to receive port numbers of the nodes upon the verification that all connections have been successfully established.

As shown in block 1012, the process flow 1000 may include the step of transmitting, using a temporary credential, a request to the API to rotate the password associated with at least one VNN authentication credential. For example, the ARP system may be configured to transmit the request to the PMS to rotate the password associated the VNN authentication credentials using the temporary credential. The PMS may update the authentication credential of the VNN as the PMS may recognize the VNN using the metadata of the user(s') authentication credential.

As shown in block 1014, the process flow 1000 may include the step of receiving, from the API, a rotated password associated with the at least one VNN authentication credential. For example, the ARP system may be configured to receive the rotated password associated with the VNN authentication credential, using the temporary credential, from the PMS.

As shown in block 1016, the process flow 1000 may include the step of updating the at least one node with the rotated password associated with the VNN authentication credential. For example, the ARP system may be configured to update the VNN authentication credential to the nodes in the AOAG using the port number received during the verification of the node connection.

As shown in block 1004 and 1018, the process flow 1000 may include the step of identifying the authentication credential, wherein, in an instance where a standalone server authentication credential or the authentication credential associated with a Business Intelligence (BI) server is identified, identify the standalone server authentication credential or the authentication credential associated with the BI server. For example, the ARP system may be configured to identify the standalone server authentication credential from the PMS, whereby the ARP system may be configured to check the existence of the standalone server and to verify the connection. Additionally, and in some embodiments, with respect to the authentication credential associated with the BI servers the ARP system may be configured to search in the metadata information storage based on the authentication credentials from the PMS to locate the target object within the SSRS servers, the SSIS servers, or the SSAS servers, where information of authentication credentials from the PMS does not comprise the information or data to locate the target object within the SSRS servers, the SSIS servers, or the SSAS servers. In some embodiments, the authentication credential associated with the BI servers may comprise the report authentication credential in SSRS server, the package authentication credential in a SSIS server, the package configuration authentication credential in SSIS server, the multi-dimensional cube authentication credential in the SSAS server, and/or the tabular cube authentication credential in the SSAS server.

As used herein, the standalone server may refer to a server that operates independently, without relying on other servers or systems in the network for the standalone server's core functionality. In some embodiments, the PMS may be configured to recognize the standalone server in the multi-server network and to connect to the standalone server, whereby the PMS may be configured to update the standalone authentication credential with the rotated password when the user(s) request to rotate the password of the standalone server. Further, in some embodiments, the PMS may be configured to update the standalone authentication credential with the rotated password when the ARP system requests, using the temporary credential, to rotate the standalone authentication credentials.

As used herein, in some embodiments, the Business Intelligence (BI) server refers to a server to assist an entity with extracting significant findings from the entity's data, whereby the entity may facilitate data-driven decision-making processes. The BI servers may comprise the SSRS server, the SSIS server, and/or the SSAS server.

As shown in block 1020, the process flow 1000 may include the step of transmitting, using a temporary credential, a request to the API to rotate the password associated with at least one standalone server authentication credential and/or the authentication credential associated with the BI server. For example, the ARP system may be configured to transmit the request, using the temporary credential, to the PMS to rotate the password associated with the standalone authentication credential, the report authentication credential, the package authentication credential, the package configuration authentication credential, the multi-dimensional cube authentication credential, and/or the tabular cube authentication credential.

In some embodiments, the PMS may be configured to recognize the standalone server in the multi-server network and to connect to the standalone server, whereby the PMS may be configured to update the standalone authentication credential with the rotated password when the user(s) request to rotate the password of the standalone server. Further, and in some embodiments, the PMS may be configured to update the standalone authentication credential with the rotated password when the ARP system request, using the temporary credential, to rotate the standalone authentication credentials. Thus, as regards to the block 1020, the PMS may be configured to update the standalone authentication credential with the rotated password within the standalone server in response to the request from the ARS, using the temporary credential, to rotate the password associated with the standalone authentication credential.

As shown in block 1022, the process flow 1000 may include the step of receiving, from the API, a rotated password associated with the at least one the authentication credential associated with the BI server. In some embodiments, the ARP system may be configured to receive the rotated password associated with the report authentication credential, the package authentication credential, the package configuration authentication credential, the multi-dimensional cube authentication credential, and/or the tabular cube authentication credential, using the temporary credential, from the PMS.

As shown in block 1024, the process flow 1000 may include the step of updating the at least one authentication credential associated with the SSRS server with the rotated password. In some embodiments, the ARP system may be configured to update the report authentication credential with the rotated password based on the location identified during the process in block 1004 and 1018 within the SSRS server.

As shown in block 1026, the process flow 1000 may include the step of updating the at least one authentication credential associated with the SSIS server with the rotated password. In some embodiments, the ARP system may be configured to update the package authentication credential and the package configuration authentication credential with the rotated password based on the location identified during the process in block 1004 and 1018 within the SSIS server.

As shown in block 1028, the process flow 1000 may include the step of updating the at least one authentication credential associated with the SSAS server with the rotated password. In some embodiments, the ARP system may be configured to update the multi-dimensional cube authentication credential and the tabular cube authentication credential with the rotated password based on the location identified during the process in block 1004 and 1018 within the SSAS server.

In some embodiments, the ARP system may be configured to terminate the process and, in each step of the process flow 1000, to transmit an error code and an error report to a user managing the ARP system when the process is not completed. For example, in the step of the block 1008, the ARP system may be configured to terminate the process and to transmit an error code with the error report when all the connection to the node is not verified. In some embodiments, the ARP system may be configured to transmit a success code and a success report to a user managing the ARP system when the process is completed.

In some embodiments, the multi-server network may comprise multiple standalone servers, AOAGs and/or associated VNNs, SSRS servers, SSIS servers, and/or SSAS servers. Each of the servers may comprise multiple authentication credentials associated with each of the servers. The ARP system may be configured to operate the process flow 1000 to multiple servers, sequentially and/or parallelly.

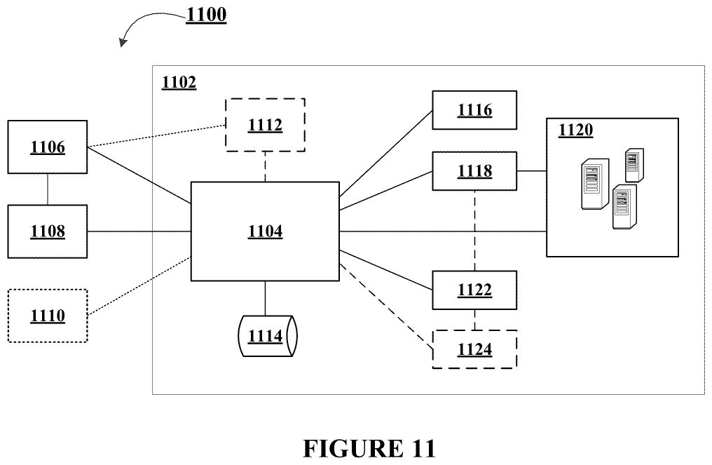

FIG. 11 illustrates the overall components associated with ARP system in multi-server environment 1100, in accordance with an embodiment of the disclosure. As shown in FIG. 11, a multi-server environment 1100 contemplated herein may comprise the user(s) access system 1106, the external PMS 1108, the external system 1110, and/or a multi-server network 1102 that comprises the ARP system 1104, the internal PMS 1112, the metadata information storage 1114, the standalone type server(s) 1116, the VNN(s) 1118, the high availability cluster(s) 1120, the business intelligence (BI) server(s) 1122, and any other server(s) 1124 that needs password rotating requirement within the multi-server network 1102. FIG. 11 illustrates only one example of an embodiment of the multi-server environment 1100, and it will be appreciated that in other embodiments one or more of the systems, devices, and/or servers may be combined into a single system, device, or server, or be made up of multiple systems, devices, or servers. Also, the multi-server environment 1100 may comprise multiple systems, same or similar to ARP system 1104, with each system providing portions of the necessary operations (e.g., as a system covering portion of the multi-server network).

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for automatically rotating password in multi-server environment, the system comprises:
a memory device with computer-readable program code stored thereon;
at least one processing device operatively coupled to the at least one memory device and the at least one communication device, wherein executing the computer-readable code is configured to cause the at least one processing device to:
identify, from at least one of an external source or an internal source, at least one authentication credential comprising a password rotation requirement associated with at least one server;
transmit, using a temporary credential, a request to an application programming interface (API) to rotate passwords associated with the at least one authentication credential;
receive, from the API, the rotated password associated with the at least one authentication credential; and
update the at least one authentication credential with the rotated password.

2. The system of claim 1, wherein executing the computer-readable code is configured to cause the at least one processing device to:
store the at least one authentication credential comprising the password rotation requirement in at least one data storage.

3. The system of claim 1, wherein the external source is a data storage component or an API metadata from the API, or the internal source comprises a server metadata associated with the at least one server.

4. The system of claim 1, wherein the temporary credential is a token, and wherein the token comprises an automatic expiration at a pre-defined threshold time.

5. The system of claim 1, wherein the at least one authentication credential is associated with at least one of: a standalone server authentication credential, a Virtual Network Name (VNN) authentication credential that has access to an Always-On-Always-Available Group (AOAG), a report authentication credential in a Structured Query Language (SQL) Server Reporting Services (SSRS) server, a package authentication credential in a SQL Server Integration Services (SSIS) server, a package configuration authentication credential in SSIS server, a multi-dimensional cube authentication credential in a SQL Server Analysis Services (SSAS) server, or a tabular cube authentication credential in the SSAS server.

6. The system of claim 5, wherein executing the computer-readable code is further configured to cause the at least one processing device to:
connect at least one node associated with the AOAG to the VNN authentication credential, wherein the authentication credential is the VNN authentication credential; and
update the at least one node with the rotated password associated with the VNN authentication credential.

7. The system of claim 5, wherein executing the computer-readable code is further configured to cause the at least one processing device to:
parse SSRS server to identify the at least one of report authentication credential, wherein the authentication credential is the report authentication credential;
update the report authentication credential with the rotated password associated with the report authentication credential.

8. The system of claim 5, wherein executing the computer-readable code is further configured to cause the at least one processing device to:
parse at least one file system, at least one database, and at least one SSIS database (SSISDB) to identify the package authentication credential, the package configuration authentication credential, or a value type of the package, wherein the authentication credential is the package authentication credential or the package configuration authentication credential; and
update the package authentication credential,
wherein, in an instance where the package authentication credential and the package configuration authentication credential are identified, update the package authentication credential and the package configuration authentication credential with the rotated password, or
wherein, in an instance where the value type of the package is identified, update the package authentication credential with the rotated password.

9. The system of claim 5, wherein executing the computer-readable code is further configured to cause the at least one processing device to:
parse the SSAS server;
identify, based on the parsing of the SSAS server, a multi-dimensional cube format of the SSAS server or a tabular cube format of the SSAS server, wherein the multi-dimensional cube format comprises the multi-dimensional cube authentication credential and wherein the tabular cube format comprises the tabular cube authentication credential; and
update the multi-dimensional cube authentication credential or the tabular cube authentication credential,
wherein, in an instance where the multi-dimensional cube format is identified, update the multi-dimensional cube authentication credential with the rotated password, or
wherein, in an instance where the tabular cube format is identified, update the tabular cube authentication credential with the rotated password.

10. A computer program product for automatically rotating password in multi-server environment, the computer program product comprising a non-transitory computer-readable medium comprising code causing an apparatus to:
identify, from at least one of an external source or an internal source, at least one authentication credential comprising a password rotation requirement associated with at least one server;
transmit, using a temporary credential, a request to an application programming interface (API) to rotate passwords associated with the at least one authentication credential;
receive, from the API, the rotated password associated with the at least one authentication credential; and
update the at least one authentication credential with the rotated password.

11. The computer program product of claim 10, wherein the at least one authentication credential is associated with at least one of: a standalone server authentication credential, a VNN authentication credential that has access to an AOAG, a report authentication credential in a SSRS server, a package authentication credential in a SSIS server, a package configuration authentication credential in SSIS server, a multi-dimensional cube authentication credential in a SSAS server, or a tabular cube authentication credential in the SSAS server.

12. The computer program product of claim 11, wherein executing the instructions further causes the processing device to:
connect at least one node associated with the AOAG to the VNN authentication credential, wherein the authentication credential is the VNN authentication credential; and
update the at least one node with the rotated password associated with the VNN authentication credential.

13. The computer program product of claim 11, wherein executing the computer-readable code is further configured to cause the at least one processing device to:
parse SSRS server to identify the at least one of report authentication credential, wherein the authentication credential is the report authentication credential;
update the report authentication credential with the rotated password associated with the report authentication credential.

14. The computer program product of claim 11, wherein executing the computer-readable code is configured to cause the at least one processing device to:
parse at least one file system, at least one database, and at least one SSISDB to identify the package authentication credential, the package configuration authentication credential, or a value type of the package, wherein the authentication credential is the package authentication credential or the package configuration authentication credential; and
update the package authentication credential,
wherein, in an instance where the package authentication credential and the package configuration authentication credential are identified, update the package authentication credential and the package configuration authentication credential with the rotated password, or
wherein, in an instance where the value type of the package is identified, update the package authentication credential with the rotated password.

15. The computer program product of claim 11, wherein executing the computer-readable code is configured to cause the at least one processing device to:
parse the SSAS server;
identify, based on the parsing of the SSAS server, a multi-dimensional cube format of the SSAS server or a tabular cube format of the SSAS server, wherein the multi-dimensional cube format comprises the multi-dimensional cube authentication credential and wherein the tabular cube format comprises the tabular cube authentication credential; and
update the multi-dimensional cube authentication credential or the tabular cube authentication credential,
wherein, in an instance where the multi-dimensional cube format is identified, update the multi-dimensional cube authentication credential with the rotated password, or
wherein, in an instance where the tabular cube format is identified, update the tabular cube authentication credential with the rotated password.

16. A method for automatically rotating password in multi-server environment, the method comprising:
identifying, from at least one of an external source or an internal source, at least one authentication credential comprising a password rotation requirement associated with at least one server;
transmitting, using a temporary credential, a request to an application programming interface (API) to rotate passwords associated with the at least one authentication credential;
receiving, from the API, the rotated password associated with the at least one authentication credential; and
updating the at least one authentication credential with the rotated password.

17. The method of claim 16, wherein the at least one authentication credential is associated with at least one of: a standalone server authentication credential, a VNN authentication credential that has access to an AOAG, a report authentication credential in a SSRS server, a package authentication credential in a SSIS server, a package configuration authentication credential in SSIS server, a multi-dimensional cube authentication credential in a SSAS server, or a tabular cube authentication credential in the SSAS server.

18. The method of claim 17, wherein the method further comprises:
parsing SSRS server to identify the at least one of report authentication credential, wherein the authentication credential is the report authentication credential;
updating the report authentication credential with the rotated password associated with the report authentication credential.

19. The method of claim 11, wherein the method further comprises:
parsing at least one file system, at least one database, and at least one SSISDB to identify the package authentication credential, the package configuration authentication credential, or a value type of the package, wherein the authentication credential is the package authentication credential or the package configuration authentication credential; and
updating the package authentication credential,
wherein, in an instance where the package authentication credential and the package configuration authentication credential are identified, update the package authentication credential and the package configuration authentication credential with the rotated password, or
wherein, in an instance where the value type of the package is identified, update the package authentication credential with the rotated password.

20. The method of claim 5, wherein the method further comprises:
parsing the SSAS server;
identifying, based on the parsing of the SSAS server, a multi-dimensional cube format of the SSAS server or a tabular cube format of the SSAS server, wherein the multi-dimensional cube format comprises the multi-dimensional cube authentication credential and wherein the tabular cube format comprises the tabular cube authentication credential; and
updating the multi-dimensional cube authentication credential or the tabular cube authentication credential,
wherein, in an instance where the multi-dimensional cube format is identified, updating the multi-dimensional cube authentication credential with the rotated password, or
wherein, in an instance where the tabular cube format is identified, updating the tabular cube authentication credential with the rotated password.
